(19) United States
(12) Patent Application Publication
(10) Pub. No.: US 2006/0271246 A1
(43) Pub. Date: Nov. 30, 2006

(54) Systems and methods for remote vehicle management

(76) Inventors: Richard Bell, San Antonio, TX (US); Craig Blaida, Boerne, TX (US); Steven Lawrence, Dublin, NH (US)

Correspondence Address: CRUTSINGER & BOOTH, 1601 ELM STREET, SUITE 1950, DALLAS, TX, 752014744, US

(21) Appl. No.: 11/140,542

(22) Filed: May 27, 2005

(51) Int. Cl. G01C 21/00

(52) U.S. Cl. 701/1; 701/213

(57) ABSTRACT

A system is provided that is adapted to be operably connected to a vehicle for use in management of the vehicle. The system includes: a computer; a wireless communication module operably connected to the computer; an audio interface operably connected to the computer; a GPS receiver module operably connected to the computer; at least one vehicle condition sensor operably connected to the computer; and a local control interface operably connected to the computer. According to a first aspect of the invention, the system further includes an engine start/stop controller operably connected to the computer. According to a second aspect of the invention, the system further includes a subscriber identity module (“SIM”) operably connected to the computer. According to a third aspect of the invention, the system further includes a gyroscope module operably connected to the GPS receiver module. According to yet another aspect of the invention, a method is provided for controlling the engine idle time of a vehicle. The method includes the steps of: operatively connecting at least one temperature sensor to measure the temperature of at least one part of the vehicle; operatively connecting the at least one temperature sensor to a computer; operatively connecting an engine start/stop controller to the engine of the vehicle; operatively connecting the engine start/stop controller to the computer; using the computer to start the engine when the at least one temperature sensor reports a temperature that is outside of a settable temperature range; and using the computer to stop the engine when the at least one temperature sensor reports a temperature that is within a settable temperature range.

### TECHNICAL FIELD

The systems and methods of the invention relate to vehicle management, in general, and more particularly, the management of the communication, location, monitoring, and control for a vehicle.

### BACKGROUND OF THE INVENTION

Many businesses own a large number, or fleet, of motor vehicles. Such businesses include, for example, trucking companies, passenger bus companies, truck and car leasing companies, and companies operating or leasing heavy equipment, such as mobile cranes, etc. Fleet vehicles are usually entrusted to individual operators or drivers over the road, sometimes for extended periods. Thus, it is desirable to have as much information and communication as possible for each vehicle that is being remotely operated. Various efforts have been made to provide certain kinds of such information and communication, but no system provides the desired range of communication, information, and control functionalities.

U.S. Pat. No. 5,416,712 issued May 16, 1995 and having for named inventors George J. Geier, Ardalan Heshmati, Kelly G. Johnson, and Patricia W. McLain discloses in the Abstract thereof: a combined GPS and dead-reckoning (DR) navigation sensor for a vehicle in which a pair of modifications are made to an otherwise conventional Kalman filter. Process noise is adapted to cope with scale factor errors associated with odometer and turning rate sensors, and correlated measurement error processing is added. When only two Doppler measurements (PRRs), or three with an awkward three-satellite geometry, are available, DR error growth can nevertheless be controlled. The measurement error correlations in the conventional Kalman filter covariance propagation and update equations are explicitly accounted for. Errors induced by selective availability periods are minimized by these two modifications. U.S. Pat. No. 5,416,712 is incorporated herein by reference in its entirety.

U.S. Pat. No. 5,442,553 issued Aug. 15, 1995 and having for named inventor Louis C. Parrillo discloses in the Abstract thereof: A transceiver and additional memory are connected to the microprocessor in a vehicle so that all, or selected portions, of operating data is stored in the memory and periodically transmitted to a remote station. The data is diagnosed at the remote station and, for minor repairs, a fix is transmitted back to the vehicle. The information for a large population of vehicles is used by the manufacturer to determine if a problem is generic to a specific model and to generate repairs and/or model changes. U.S. Pat. No. 5,442,553 is incorporated herein by reference in its entirety.

U.S. Pat. No. 5,844,473 issued Dec. 1, 1998 and having for named inventor Richard A. Kaman discloses in the Abstract thereof: An apparatus for remotely collecting and reporting an indicia of use of a vehicle. The apparatus includes an accumulator of the indicia of vehicle use operably coupled to the vehicle and a transceiver coupled to the accumulator and responsive to a received information request for transmitting the indicia of vehicle use. U.S. Pat. No. 5,844,473 is incorporated herein by reference in its entirety.

U.S. Pat. No. 6,253,129 issued Jun. 26, 2001 and having for named inventors Paul C. Jenkins, David V. Deal, Thomas G. Cuthbertson, James W. Morton, Andrew D. Smith, David R. Hoy, and Gerald W. Egeberg discloses in the Abstract thereof: A commercial vehicle fleet management system which integrates a vehicle on-board computer, a precise positioning system, and communication system to provide automated calculating and reporting of jurisdictional fuel taxes, road use taxes, vehicle registration fees, and the like. In a further aspect, there is provided an online mobile communication system and a system for monitoring carrier vehicle efficiency and vehicle driver performance. U.S. Pat. No. 6,253,129 is incorporated herein by reference in its entirety.

U.S. Pat. No. 6,259,362 issued Jul. 10, 2001 and having for named inventor Xing Ping Lin discloses in the abstract thereof: A system for a vehicle, wherein the system includes transmitter components, located at the vehicle, that are operable to send communication that conveys a vehicle system status. A portable receiver unit is operable to receive the communication that conveys the vehicle system status. An operator of the vehicle carries the portable receiver unit upon leaving the vehicle. A controller senses a condition indicative of the vehicle operator leaving the vehicle and enables the communication from the transmitter components to the portable receiver unit in response to the sensed condition indicative of the vehicle operator leaving the vehicle. Preferably, a device enables operation of the portable receiver unit in response to the sensed condition indicative of the vehicle operator leaving the vehicle. U.S. Pat. No. 6,259,362 is incorporated herein by reference in its entirety.

U.S. Pat. No. 6,295,492 issued Sep. 25, 2001 and having for named inventors Brook W. Lang and Mark H. Tyerman discloses in the Abstract thereof: A system for transmitting, collecting and displaying diagnostic and operational information from one or more motor vehicles to a central server connected to a wide area network. The system is designed to be used with an existing on-board diagnostic system found in most motor vehicles manufactured today. The system includes a translator device capable of translating the codes from an on-board diagnostic connector into computer readable files such as ASCII files. The translator device may be connected to an on-board computer that includes a wireless modem capable of connecting to a wireless communication network and eventually to a wide area network. A central server is connected to the wide area network which receives and stores information from the on-board computer. Authorized users may connect to central server via the wide area network and request information therefrom regarding selected motor vehicles. All of the information may be presented in a single interface. U.S. Pat. No. 6,295,492 is incorporated herein by reference in its entirety.

U.S. Pat. No. 6,370,454 issued Apr. 9, 2002 and having for named inventor James T. Moore discloses in the Abstract thereof: A method and apparatus for the maintenance of mechanized equipment such as an automobile is disclosed. Various sensors located within the automobile provide information to an on-board computing device, a personal digital assistant, or a local computing device which are networkable to a network such as the Internet. The information may be transferred across the network, and service obtained appropriately. Information located in various remote servers relating to the performance and service of the vehicle may be downloaded across the network and easily used in servicing and maintaining the vehicle. Optionally, the apparatus includes a notification system, such as an email system, for notifying of, scheduling, and/or paying for services. U.S. Pat. No. 6,370,454 is incorporated herein by reference in its entirety.

U.S. Pat. No. 6,411,894 issued Jun. 25, 2002 and having for named inventors Takeyoshi Yamamoto and Masahito Hata discloses in the Abstract thereof: A navigation device includes a determination means which determines whether or not to activate tunnel mode function based on characteristic data of the tunnel read from the database, a vehicle speed detected by the vehicle speed detection means and a vehicle position detected by the vehicle position detection means, and a control means which displays characteristics of the tunnel to be traveled through on a display means based on a command signal from the determination means to activate the tunnel mode function and which activates various on-vehicle devices in the tunnel mode function. U.S. Pat. No. 6,411,894 is incorporated herein by reference in its entirety.

U.S. Pat. No. 6,429,773 issued Aug. 6, 2002 and having for named inventor Marc P. Schuyler discloses in the Abstract thereof: a system for remotely communicating with a vehicle including a wireless device, a security gateway, an on-board computer coupled to one or more sensors or controls, and a web interface that provides for graphical interface between the vehicle and a remote individual. More particularly, a vehicle owner uses the Internet to directly communicate with the vehicle and, using this linkage, can monitor vehicle status (e.g., oil level and quality), read vehicle statistics such as odometer reading and interrogate other sensors as sampled by the on-board computer. Preferably, the owner can also change security functions such as door lock, alarm on, ignition kill “on,” and similar functions using this web interface. To assist any vehicle owner with communication with a vehicle, the on-board components or owner's remote browser preferably permit selective downloading of skins, such that a wide variety of customized interfaces may be used to interact with the vehicle, no matter the owner's level of knowledge and sophistication with the vehicle. U.S. Pat. No. 6,429,773 is incorporated herein by reference in its entirety.

U.S. Pat. No. 6,438,467 issued Aug. 20, 2002 and having for named inventor Ernest Edmond Pacsai discloses in the Abstract thereof: A system for a vehicle that has a plurality of inflatable tires, wherein the system has a plurality of sensor units associated with the plurality of tires. Each of the sensor units senses inflation pressure of the associated tire and transmits a signal indicative of the sensed tire inflation pressure. A portable unit of the system is located remote from the vehicle and is operable by a person to transmit a signal that conveys a remote control function request. The portable unit also receives a signal indicative of sensed tire inflation pressure and provides an indication of tire inflation pressure to the person. A control/communication unit is located at the vehicle and receives the signal conveying the remote function request and causes performance of the remotely requested function. The control/communication unit also receives the signals transmitted from the sensor units and transmits the signal indicative of sensed tire inflation pressure to the portable unit. U.S. Pat. No. 6,438,467 is incorporated herein by reference in its entirety.

U.S. Pat. No. 6,594,579 issued Jul. 15, 2003 and having for named inventors Larkin Hill Lowrey, Bruce Lightner, Mathew J. Banet, Diego Borrego, Chuck Meyers, and James Cowart discloses in the Abstract thereof: A method for characterizing a vehicle's fuel efficiency including generating parameter-related data from the vehicle that describes at least one of a plurality of vehicle parameters including: vehicle speed, fuel level, engine speed, load, mass air flow, manifold air pressure, odometer reading; transferring the parameter-related data to a wireless appliance including a wireless transmitter; transmitting the parameter-related data with the wireless transmitter over an airlink to a host computer system; and analyzing the transmitted parameter-related data with the host computer system to calculate the vehicle's fuel efficiency, wherein the analyzing involves determining an amount of fuel consumed by the vehicle during an interval, determining a distance traveled by the vehicle during the interval, and calculating the vehicle's fuel efficiency from the amount of fuel consumed and the distance traveled during the interval. U.S. Pat. No. 6,594,579 is incorporated herein by reference in its entirety.

U.S. Pat. No. 6,662,108 issued Dec. 9, 2003 and having for named inventors Ronald Hugh Miller and Perry Robinson MacNeille discloses in the Abstract thereof: a method for operating a pre-crash sensing system for a first vehicle having a global positioning system (GPS). The method includes receiving an acquired GPS satellite identifier and generating first vehicle location data with the GPS system. The first vehicle location is transmitted along with the satellite identifier to a second vehicle across a wireless vehicle network. Location information is also received for a detected second vehicle. In response, the first vehicle transmits a request for updated second vehicle location information using a coordinating satellite identifier. The coordinating satellite identifier is then used by the second vehicle to update the second vehicle location data. In this way, both communicating vehicles are generating and sharing location information from a commonly acquired GPS source. U.S. Pat. No. 6,662,108 is incorporated herein by reference in its entirety.

U.S. Pat. No. 6,774,779 issued Aug. 10, 2004 and having for named inventor Sheng Hsiung Lin discloses in the Abstract thereof: A vehicle security system with a tire monitoring device comprises at least one vehicle sensor for detecting unauthorized actions, at least one sensor module, a controller and a remote unit. The sensor module is attached to a tire of a vehicle for sensing the tire conditions and transmitting a first radio frequency signal including the tire conditions. The controller is attached to the vehicle, and is used for generating a plurality of signals of security system conditions in response to the at least one vehicle sensor and for receiving and operating the first radio frequency signal including the tire condition. The controller then is used for transmitting a second radio frequency signal including the security system condition signals and the tire conditions. The remote unit receives the second radio frequency signal and generates a plurality of remote indications for showing the security system conditions and the tire conditions. U.S. Pat. No. 6,774,779 is incorporated herein by reference in its entirety.

U.S. Pat. No. 6,879,894 issued Apr. 12, 2005 and having for named inventors Bruce Lightner, Mathew J. Banet, Diego Borrego, Larkin Hill Lowrey, and Chuck Meyers discloses in the Abstract thereof: a method and device for characterizing a vehicle's emissions. These systems feature the steps of generating a data set from the vehicle that includes at least one of the following: diagnostic trouble codes, status of a MIL, and data relating to I/M readiness flags; and then transferring the data set to a wireless appliance that features a microprocessor and a wireless transmitter in electrical contact with the microprocessor. The wireless appliance then transmits a data packet comprising the data set (or a version of the data set) with the wireless transmitter over an airlink to a wireless communications system. Here, ‘a version of the data set’ means a representation (e.g., a binary representation) of data in the data set, or data calculated or related to data in the data set. U.S. Pat. No. 6,879,894 is incorporated herein by reference in its entirety.

U.S. Patent Application Publication No. 2003/0187571 published Oct. 2, 2003 and having for named inventors Jeremy D. Impson and Nader Mehravari discloses in the Abstract thereof: A system and method for mobile platform real-time collection, transmission, and processing of an array of environmental and vehicle-related data in the context of an Intelligent Transportation System (ITS) network. The system and method provide enhanced in-vehicle data collection, enhanced communications capability between the vehicle and the ITS system, and enhanced ITS implementation functionality to provide real-time incident reporting to ITS users. U.S. Patent Application Publication No. 2003/0187571 is incorporated herein by reference in its entirety.

U.S. Patent Application Publication No. 2003/0191568 published Oct. 9, 2003 and having for named inventor David S. Breed discloses in the Abstract thereof: Control system and method for controlling a vehicle or a component of a vehicle in which an inertial reference unit includes accelerometers and gyroscopes which provide data on vehicle motion and a processor processes the data and controls the vehicle or the component of the vehicle based thereon. Movement of the vehicle may be controlled via control over servos, such as a servo associated with the braking system, a servo associated with the drive train or throttle and a servo associated with the steering system. A display to the driver can also be controlled by the processor to provide data on vehicle motion or data or information derived from the data on vehicle motion. Optionally, a Kalman filter is coupled to the processor for optimizing the data on vehicle motion from the inertial reference unit. U.S. Patent Application Publication No. 2003/0191568 is incorporated herein by reference in its entirety.

U.S. Patent Application Publication No. 2005/0060070 published Mar. 17, 2005 and having for named inventors Michael Kapolka, Sam Chang, Andrew Smith, Brian Crull, Dennis Essenmacher, Andrew Ditchfield, William Bromley, Brian Carl, Gregory A. Dils, Hassanayn Machlab El-Hajj, Gregory J. Kelsey, Mark Brown, and Nik Neymeyer discloses in the Abstract thereof: A system, method, and computer program product is provided for remote vehicle diagnostics, telematics, monitoring, configuring, and reprogramming. The system includes an on-board unit disposed on at least one vehicle, an application-service-provider infrastructure, and an interface. The on-board unit is operable to send and receive data corresponding to at least one vehicle operating characteristic. Located on the application-service-provider infrastructure is an application suite. The application suite includes at least one modular application each of which has an associated function that processes said data obtained via the on-board unit. The interface is operable to select from the application suite at least one of the modular applications that will use the associated function to diagnose, monitor, configure, reprogram, and/or obtain telematic information from the at least one vehicle. U.S. Patent Application Publication No. 2005/0060070 is incorporated herein by reference in its entirety.

Thus, a long-felt and continuing need exists for improved systems and methods that provide a vehicle owner or vehicle fleet management communication, location, monitoring, and control for a vehicle.

### SUMMARY OF THE INVENTION

According to the invention, a system is provided that is adapted to be operably connected to a vehicle for use in management of the vehicle. The system includes: a computer; a wireless communication module operably connected to the computer; an audio interface operably connected to the computer; a GPS receiver module operably connected to the computer; at least one vehicle condition sensor operably connected to the computer; and a local control interface operably connected to the computer.

According to a first aspect of the invention, the system further includes an engine start/stop controller operably connected to the computer.

According to a second aspect of the invention, the system further includes a subscriber identity module (“SIM”) operably connected to the computer.

According to a third aspect of the invention, the system further includes a gyroscope module operably connected to the GPS receiver module.

According to yet another aspect of the invention, a method is provided for controlling the engine idle time of a vehicle. The method includes the steps of: operatively connecting at least one temperature sensor to measure the temperature of at least one part of the vehicle; operatively connecting the at least one temperature sensor to a computer; operatively connecting an engine start/stop controller to the engine of the vehicle; operatively connecting the engine start/stop controller to the computer; using the computer to start the engine when the at least one temperature sensor reports a temperature that is outside of a settable temperature range; and using the computer to stop the engine when the at least one temperature sensor reports a temperature that is within a settable temperature range.

These and further aspects of the invention are most advantageously and synergistically practiced together. These and further aspects and advantages of the invention will become apparent to persons skilled in the art from the following drawings and detailed description of presently most-preferred embodiments of the invention.

### BRIEF DESCRIPTION OF THE DRAWING

The accompanying drawings are incorporated into and form a part of the specification to illustrate several examples of the present invention. These drawings together with the description serve to explain the principles of the invention. The drawings are only for illustrating preferred and alternative examples of how the invention can be made and used and are not to be construed as limiting the inventions to the illustrated and described examples. The various advantages and features of the present invention will be apparent from a consideration of the drawings in which:

FIG. 1 is a block diagram illustrating an overall system according to one preferred embodiment of the invention including all the functionalities of remote engine start, using a SIM card, and using a gyroscope to add dead-reckoning functionality when a GPS signal is unavailable;

FIG. 2 is a block diagram illustrating an example for a data handling process using data collected from the vehicle system, which can be selectively transmitted via an airlink to a central data processing station remote from the vehicle and/or stored locally to be downloaded locally via a USB connection for separate independent computer processing and data reporting;

FIG. 3 is an illustration of a physical system according to one embodiment of the invention;

FIGS. 4a and 4b are illustrations of a SIM card; and

FIGS. 5a-5i are a set of preliminary schematics of the electronics for one embodiment of a system according to the invention.

### DETAILED DESCRIPTION OF PREFERRED EMBODIMENTS

As previously mentioned, fleet vehicles are usually entrusted to individual operators or drivers over the road. Thus, it is desirable to have as much information and communication as possible for each vehicle that is being remotely and independently operated.

In the case of a fleet vehicle, for example, both business management and the vehicle operator desire to have the benefit of constantly available communications. From management's perspective, it is desirable to be able to reach the operator on the road to request status information or change instructions. And from the operator's perspective, when on the road the operator often finds a need for more detailed instructions, to report difficulties, or even call for emergency assistance.

Both the business management and the vehicle operator desire to know the location of the vehicle with as much accuracy and precision as possible. Management desires to always know that the vehicle is where it is supposed to be. The operator also desires to always know where the vehicle is and to have directional guidance.

Both the business management and the vehicle operator desire to constantly monitor various related and unrelated vehicle conditions such as fuel level, battery voltage, tire pressure, engine data, emissions, vehicle speed, acceleration, braking, mileage, payload tracking, passenger tracking, payload temperature, cabin environmental conditions, etc. This information needs to be communicated to management. From management's perspective, when on the road the operator of the vehicle cannot be personally supervised, especially for safety concerns such as speeding or reckless driving. Management desires a system that would have the capability to monitor such conditions, periodically report them to management, or immediately report any out-of-parameter or unsafe conditions to management. This data can also be useful to management in making logistics planning, any required governmental reports, such as those required by the U.S. Department of Transportation (“DOT”), State-by-state DOT regulations, as may be required for emissions credit generation for trade, for example on the Chicago Climate Exchange (CCX), or pollution abatement reporting. Furthermore, this data and reporting may help reduce insurance costs by decreasing claims based on drivers become more cautious under such supervision or being terminated for unsafe driving concerns; From the operator's perspective, such automatic machine-to-machine (“M2M”) reporting would greatly reduce the burden of making paper or verbal reports to management.

In addition, management or the vehicle operator sometimes desires to remotely control at least certain aspects of the vehicle's operations. One of the more important considerations for emissions control is starting the vehicle's engine and allowing it idle for a sufficient period to warm up before beginning to operate the vehicle at higher engine speeds. This typically takes about 30 minutes or more, depending on the ambient temperature. In the past, this has typically been accomplished by having the operator physically go to the vehicle to manually operate the vehicle's ignition system to start the engine. The operator would then either have to wait an inconvenient amount of time for the engine to warm up, often at the company's time and expense, or proceed to operate the vehicle before the engine has warmed to its proper operating temperature, producing undesirably high emissions levels.

As a further problem with controlling engine idle time, both management and the operator of a vehicle desire to minimize engine idle time, which in turn reduces fuel consumption, emissions, idle fines imposed by some locales, reduction of engine wear and tear due to cold starts, and keeping the engine running when a low batter voltage would prevent a restart. These all add up to cost savings for the vehicle owner. It is also desirable to minimize the engine idling maintained for the purposes maintaining operator cabin and/or passenger cabin spaces at a comfortable temperature. Thus, it would be desirable for both management and the operator to have some automated or semi-automated control over the engine idle time, including both starting and stopping the engine to maintain a desired minimum engine temperature to avoid cold starts and to maintain a desired cabin temperature range, but while minimizing engine idle time.

Furthermore, control of engine idle speed to adjust for ambient temperature is also helpful for controlling vehicle emissions. It would be desirable for management or the operator of the vehicle to be able to monitor and remotely control engine idle speed at vehicle start up taking into account the ambient temperature.

It is to be understood, of course, that a system for accomplishing some or all of these desired functionalities may have widespread application even for individually owned and operated vehicles.

Accordingly, to meet at least some of these needs, and most preferably all of them, a system and method are provided for vehicle management, including communications, locating, vehicle condition information, and even remote vehicle control functionalities. In general, the system is adapted to be operably connected to a vehicle for use in management of the vehicle. A method of using the system is also provided.

The present inventions will be described by referring to apparatuses and methods showing various examples of how the inventions can be made and used. In these drawings, reference characters are used throughout the several views to indicate like or corresponding parts.

As used herein and in the appended claims, the words “comprise,” “has,” and “include” and all grammatical variations thereof are each intended to have an open, non-limiting meaning that does not exclude additional elements or parts of an assembly, subassembly, or structural element.

As used herein, the words “operably connected” means connected, either directly or indirectly, to one another. The connections are in general anticipated to be electrically wired, however, some of the connections can be wireless. For example, it is contemplated that data communication between the computer and the vehicle condition sensors can be transmitted over a limited range wireless intranet link covering the vehicle.

In general, unless otherwise expressly stated, the words or terms used in this disclosure and the claims are intended to have their ordinary meaning to persons of skill in the art. Initially, as a general aid to interpretation, the possible definitions of the words or terms used herein are intended to be interpreted by reference to comprehensive general dictionaries of the English language published before or about the time of the earliest filing of this application for patent. In addition, after initially consulting such general dictionaries of the English language, the possible definitions of the words or terms used herein are intended to be interpreted by reference to appropriate engineering dictionaries, encyclopedias, treatises, and relevant prior art to which this invention pertains. From all the possible definitions, the one or more possible definitions that are consistent with the usage in this specification should be adopted.

Of course, terms made up of more than one word (i.e., compound terms), may not be found in general dictionaries of the English language. Compound terms are intended to be interpreted as a whole, and not by parsing the separate words of the compound term, which might result in absurd and unintended interpretations. In general, compound terms are to be interpreted as they would be understood in the art, consistent with the usage in this specification and with reference to the drawings.

If there is any conflict in the usages of a word or term in this specification and one or more patent documents that may be incorporated herein by reference, the one or more possible definitions that are consistent with this specification should be adopted.

It is intended that examining relevant general dictionaries, encyclopedias, treatises, prior art, and the patent record will make it possible to ascertain the appropriate meanings that would be attributed to the words and terms of the description and claims by those skilled in the art, and the intended full breadth of the words and terms will be more accurately determined. In addition, the improper importation of unintended limitations from the written description into the claims will be more easily avoided.

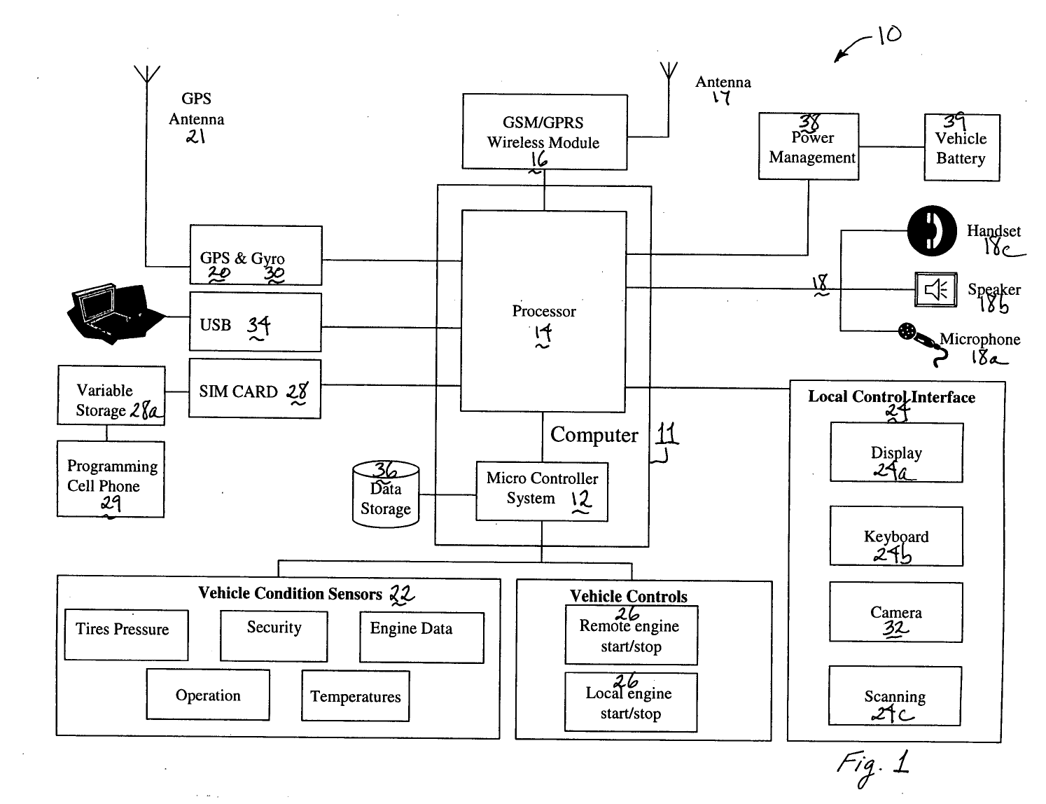

Referring now to FIG. 1 of the drawing, a block diagram of one embodiment of an overall system according to one preferred embodiment of the invention. Such a system, generally referred to by the reference numeral 10, includes: a computer 11, wherein the computer 11 preferably is embedded and preferably includes a microcontroller 12 and a processor 14 operably connected to the microcontroller; a wireless communication module 16 operably connected to the processor; an audio interface 18 operably connected to the processor; a GPS receiver module 20 operably connected to the processor; at least one vehicle condition sensor 22 operably connected to the microcontroller; and a local control interface 24 operably connected to the processor. In addition, the system 10 shown in FIG. 1 includes a remote engine start/stop controller 26, a SIM card 28 to uniquely identify the subscriber using the system, and a gyroscope 30 to add dead-reckoning functionality when adequate GPS signals are unavailable.

It is to be understood that the system 10 is controlled by any suitable computer 10. Preferably, the computer 11 is embedded in the system 10 as a special-purpose computer system that is completely encapsulated by the device it controls. In general, an “embedded” computer has specific requirements and performs pre-defined tasks, unlike a general-purpose computer.

The computing functions of the computer 11 are preferably divided between a microcontroller 12 and a processor 14. This division of labor improves the efficiency of the computer 11. This also allows the simultaneous computer processing of different kinds of tasks while reducing the need for time-splicing of the computer processing.

The microcontroller 12 is a programmable system on a chip (PSOC) that is optimized to control devices. It is a type of microprocessor emphasizing self-sufficiency and cost-effectiveness, in contrast to a general-purpose microprocessor, the kind used in a personal computer. A typical microcontroller contains all the memory and I/O interfaces needed, whereas a general purpose microprocessor requires additional chips to provide these necessary functions.

The processor 14 is for processing received information through one or more of a plurality of inputs after it has been encoded into data by other subsystems or modules of the system 10. These data are processed by the processor 14 before being sent out through one or more of a plurality of outputs to other subsystems or modules of the system 10. In the system 10, the processor 14 receives encoded data from other subsystems or modules that include, for example, the microcontroller 12, the wireless communication module 16, the audio interface 18, the GPS receiver module 20, and the local control interface 24. The processor 14 also sends data out through various outputs to the other subsystems or modules.

The wireless communication module 16 is preferably a cellular communication module, but it could be of any convenient type, including, for example, a satellite communication device if the remoteness of the circumstances warrant. An appropriate type of antenna, such as cellular antenna 17, which can be separate from the wireless communication module 16, is operably connected to the wireless communication module 16. Most preferably, the system uses the Global System for Mobile Communications standard (“GSM”), which is currently the most popular standard for mobile phones. The current ubiquity of the GSM standard makes international roaming very common with “roaming agreements” between mobile phone operators. GSM differs significantly from its predecessors in that both signaling and speech channels are digital, which means that it is seen as a second generation (2G) mobile phone system. It is to be understood, of course, that as communication technology evolves, including, for example, to third generation (3G), fourth generation (4G), and beyond, the system according to the present invention could use such advanced communication standards and protocols. “Wireless communication” means communication without cables or cords, chiefly using radio frequency and infrared waves.

According to the presently most preferred embodiment of the invention, the processor 14 and wireless communication module 16 are combined as a mobile-to-mobile (“M2M”) device such as the “Nokia 12 GSM module,” which is commercially available from Nokia. This Nokia module uses Java™ to provide a standard, well-known programming environment that enables the implementation of the application logic inside the Nokia 12. The Nokia 12 GSM module offers advanced GSM connectivity. It supports EDGE/GPRS and HSCSD with automated GSM connection establishment, and includes various integrated authentication mechanisms. Special features such as remote parameter configuration and flexible audio interface further enhance the connectivity. The Nokia 12 GSM module is equipped to provide reliable remote connections. It offers application-level watchdogs, in-built self-check mechanisms and a reliable Virtual Machine (VM) for Java™. The Nokia 12 GSM module also supports reliable in-built Internet protocols: TCP/IP for reliable data transfer; UDP/IP for audio and video streaming and HTTP for accessing Web pages. Common Object Request Broker Architecture (CORBA) is also supported for exchanging data. In addition, the Nokia 12 GSM module utilizes AutoPIN, GSM encryption and security codes. The in-built authentication mechanism includes the Challenge Handshake Authentication Protocol (CHAP), which performs password authentication whenever a connection is established. The Nokia 12 GSM module can be connected to an external Global Positioning System (GPS) device that supports the National Marine Electronics Association (NMEA) standard. This module also includes an NMEA parser that is able to parse the location data (such as location coordinates, altitude, date and time) from the output that it receives from the GPS device. This location data can be easily utilized in various Java™ applications. External microcontrollers can use AT commands to communicate with the Nokia 12 GSM module, and simple remote I/O applications can be easily controlled via text messages.

The audio interface 18 preferably includes a microphone 18a, a speaker 18b, and a privacy handset 18c. When installed in a vehicle, the microphone, speaker, and handset are adapted to be positioned near the operator's position of the vehicle for convenient access.

GPS receiver module 20 utilizes the Global Positioning System, which is a satellite navigation system used for determining a precise location and providing a highly accurate time reference almost anywhere on earth. The GPS system includes a satellite constellation of at least 24 satellites in an intermediate circular orbit (ICO) around the earth. The GPS system was designed by and is controlled by the United States Department of Defense and can be used by anyone, free of charge. The GPS system is divided into three segments: space, control, and user. The space segment comprises the GPS satellite constellation. The control segment comprises ground stations around the world that are responsible for monitoring the flight paths of the GPS satellites, synchronizing the satellites' onboard atomic clocks, and uploading data for transmission by the satellites. The user segment consists of GPS receivers used for both military and civilian applications. A GPS receiver decodes time signal transmissions from multiple satellites and calculates its position by trilateration. Based on national security concerns for its use by potential enemies, the US Department of Defense has in the past included error factors in the GPS signals, which made the GPS system less reliable and led to efforts to constantly correct for such error factors. More recently, such error factors have been reduced or eliminated. The GPS receiver module 20 is used, of course, to locate the position of the vehicle. A GPS antenna 21, which can be separate from the GPS receiver module 20, is operably connected to the GPS receiver module.

The system 10 includes at least one vehicle condition sensor 22. This can include one or more sensors for any of a wide variety of vehicle conditions. For example, it is desirable to monitor tire pressures with a tire pressure sensor for each tire, which can impact fuel efficiency, reduce or eliminate down time due to flat tires, and be a safety concern. It is also desirable to monitor the security status of the vehicle, including, for example, door sensors, window sensors, and key chain remote. In addition, a driver identification module can be included, which can be connected to the system 10. Further, it is also desirable to monitor conditions relating to the operation of the engine, such as fuel status, oil pressure, air pressure, engine compartment temperature, water (coolant) temperature, battery voltage, On Board Diagnostics revision 2 (OBDII) data, SAE J1939 Standards Collection (J1939 spec) data, and engine fire monitor. It is also within the scope of the invention to monitor other conditions, such as operator cabin temperature, passenger cabin temperature. Monitoring payload temperature can be especially important for transporting refrigerated goods or materials. Further, it is within the scope of the invention to include vehicle condition sensors for the speed of the vehicle, the compass heading, acceleration, braking, swerving, reversing, etc., any or all of which can indicate whether the operator could be operating the vehicle in a safe manner.

Of course, any or all of these types of data collected by the one or more vehicle condition sensors 22 can be periodically or automatically transmitted via the wireless module 16 according to the programming of the system 10 or downloaded locally.

The local control interface 24 allows the operator access to at least some of the functionality of the system 10. For management concerns, certain monitoring and reporting functionality would not be accessible or changeable by the operator of the vehicle. The local control interface can be any convenient apparatus and functionality. Preferably, the local control interface 24 includes at least a visual display 24a for the operator. More preferably, the local control interface 24 includes a keypad 24b, touch sensitive visual display, and/or voice-command recognition system. The operator interface 24 can also include a hand-held cellular phone for transmitting voice or text instructions to the system 10 via an airlink to the wireless module 16 or via a direct plug-in connection. Another desirable feature for the local control interface 24 includes a barcode scanner 24c and/or radio frequency identity (RFID) reader, which could be used for example to scan the operator's identity badge for time keeping purposes, to distinguish between two or more operators for the vehicle, to keep track of passengers entering and leaving the vehicle, to keep track of shipping packages or passenger luggage brought onto or removed from the vehicle, etc. Still another desirable feature for the local control interface 24 includes still or video camera for periodically or continuously monitoring the operator cabin, the passenger cabin, the payload area, and/or the vehicle surroundings, such as forward and/or backward looking areas.

According to a first aspect of the invention, the system 10 includes an engine start/stop controller 26 operably connected to the microcontroller. The engine start/stop controller 26 is adapted to be connected to the vehicle's engine ignition system, and more preferably, includes an engine throttle control to adjust engine idle speed. The system 10 and the engine start/stop controller 26 are preferably integrated with the vehicle's security system to allow the vehicle's engine to be started while maintaining other vehicle security features such as door locks. Preferably, the system 10 controls the idle time to maintain a desired engine temperature to reduce or eliminate engine cold starts, maintain desired a desired cabin temperature range, and comply with local regulations that limit idle time. In addition, the system 10 preferably has an override of these other features to keep the engine running in case a low battery voltage condition indicates the vehicle would have difficulty restarting. Preferably, the engine start/stop controller 26 is further capable of selecting or adjusting the idle speed of the engine depending on ambient temperature conditions.

Of course, the system 10 can also include other engine controllers, such as an engine stop or kill controller 26. Such a function can be useful to remotely kill the engine if the operator does not arrive at the vehicle within an expected amount of time. It can also be useful to have the system be able to automatically kill the engine in case the system 10 determines that the vehicle has traveled outside a geographic “fence” programmed into the system 10. This can also be useful if the system 10 reports a vehicle location or other operating condition to management that is outside an expected parameter to force the vehicle to come to a stop. This may be desirable, for example, if the system detects and/or reports that the vehicle is operating at an unsafe speed, a speed in excess of posted speeding limits for the vehicle's location, or if excessive acceleration, braking, or swerving is sensed by appropriate vehicle condition sensors. In addition, for example, the operator of the vehicle can be given a warning, through the audio interface 18, for example, that this will occur, which would be adequate to give the operator time to bring the vehicle to a safe parking location.

According to a second aspect of the invention, the system 10 further includes a subscriber identity module or SIM 28 operably connected to the microcontroller. The use of the SIM 28 will hereinafter be described in more detail. In addition to the SIM, removable or variable data storage 28a can be provided. Furthermore, a conventional, off-the-shelf cell phone 29 can be used to program the SIM 28.

According to a third aspect of the invention, the system 10 further includes a gyroscope module 30 operably connected to the GPS receiver module. Data from the gyroscope module 30 is integrated with data from a vehicle condition sensor 22 for the vehicle's speed, which provides a dead-reckoning estimate of the vehicle's position based on its last known position as determined by the GPS receiver 20.

According to a presently preferred embodiment of the invention, a camera 32 is operably connected to the processor. One or more still or video cameras 32 can be used for periodically or continuously monitoring the operator cabin, the passenger cabin, the payload area, and/or the vehicle surroundings, such as forward and/or backward looking areas. This information can be automatically transmitted to management in response to data that may be collected from vehicle condition sensors 22, such as speeding or swerving, or may be transmitted in to management in response to a request to the system 10 received from management.

According to a presently preferred embodiment of the invention, a data interface, such as USB interface 34 is operably connected to the processor. A USB interface 34 can be used, for example, to communicate information and/or programming from or to the system 10. It is to be understood, of course, that the data interface can be a parallel port or any other convenient design for a data interface.

According to another presently preferred embodiment of the invention, a data storage module 36 is operably connected to the microcontroller 12. The data storage module 36 can be advantageously employed to store data, information, and programming of every kind that can be gathered or received by the various modules of the system 10. Such data, information, and programming can be accessed as needed by the computer 11, downloaded to another device, or transmitted via airlink to another system for management's or other use.

According to yet another presently preferred embodiment of the invention, an electrical power regulator 38 is operably connected to the processor. The electrical power regulator 38 is adapted to be electrically connected to a vehicle battery 39. The power regulator 38 converts the vehicle battery voltage to a voltage or voltages appropriate to the electronic modules of the system 10.

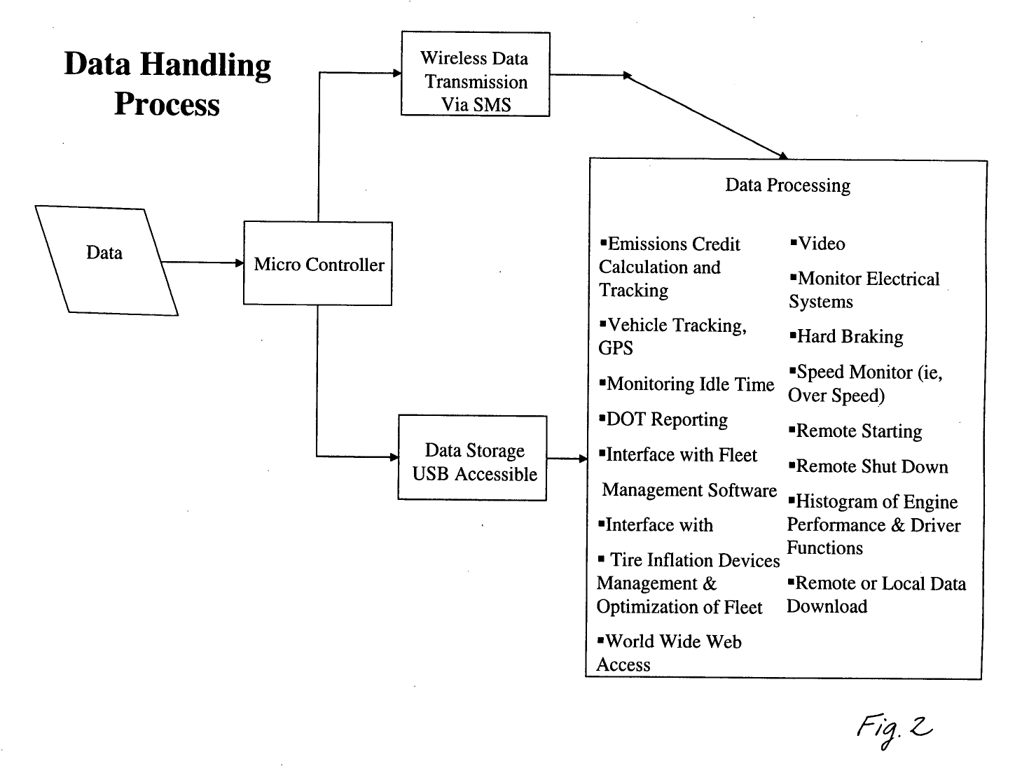

FIG. 2 of the drawing is a block diagram illustrating an example for a data handling process using data collected from the vehicle system, which can be selectively transmitted via an airlink to a central data processing station remote from the vehicle and/or stored locally to be downloaded to another computer via a USB connection for separate independent computer processing and data reporting. For example data collected from the vehicle condition sensors 22, can be sent is sent to the microcontroller 12 of the computer 11. The microcontroller 12 can selectively send the data via a wireless data transmission or use the data storage capability from which it can be downloaded to another computer via a data interface such as a USB connection. The processing and reporting of the data can be used, for example, for emissions credit calculation and tracking; vehicle tracking from the GPS data, monitoring idle time; DOT reporting; interfacing with fleet management software; interfacing with tire inflation devices; world wide web access; video access; monitoring electrical systems; monitoring hard braking; monitoring speed (e.g., over-speed); remote engine starting; remote engine shut-down; producing histograms of engine performance & driver functions; and remote or local data download.

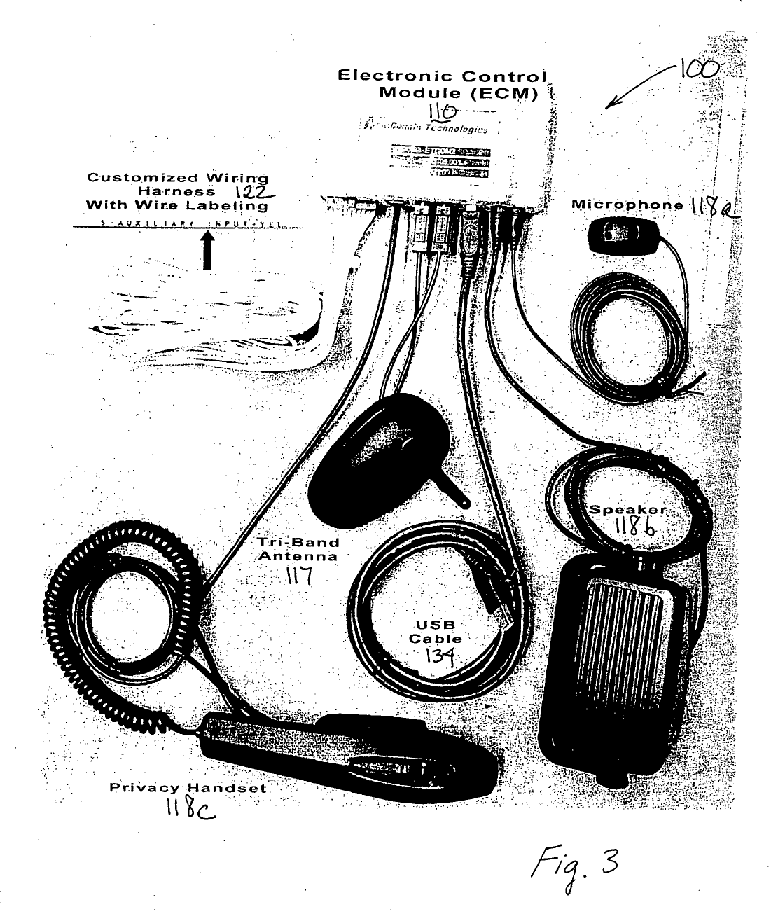

FIG. 3 is an illustration of a physical system 100 according to one embodiment of the invention. According to this embodiment, the system 100 has central electronic control module 110, which includes most of the electronic circuitry described above, such as the computer 11, the wireless communication module 16, the audio interface 18; and GPS receiver module 20 (not separately visible in FIG. 3). The central electronic control module 110 can be installed at any convenient location in the vehicle. A tri-band antenna 117 is operably connected to the central electronic control module 110. An audio interface 118 includes a microphone 118a, a speaker 118b, and a privacy handset 118c. When installed in a vehicle, the microphone, speaker, and handset are adapted to be positioned near the operator's position of the vehicle for convenient access. A wiring harness 122 operatively connected to the central electronic module 110, which is adapted to be connected to various vehicle condition sensors 22 (not shown in FIG. 3), the local control interface 24 (not shown in FIG. 3), and the vehicle controls 26 (not shown in FIG. 3). In addition, a USB cable 134 is provided.

According to the second aspect of the invention, the system and methodology includes utilizing a GSM SIM card to store configurations setting that could be used to control the operation of a Mobil communication device. Example applications of this methodology include: preventing users form changing settings of the communication device; and providing customization to a communication device that would not normally have the direct ability to be customized (i.e. limited user interface).

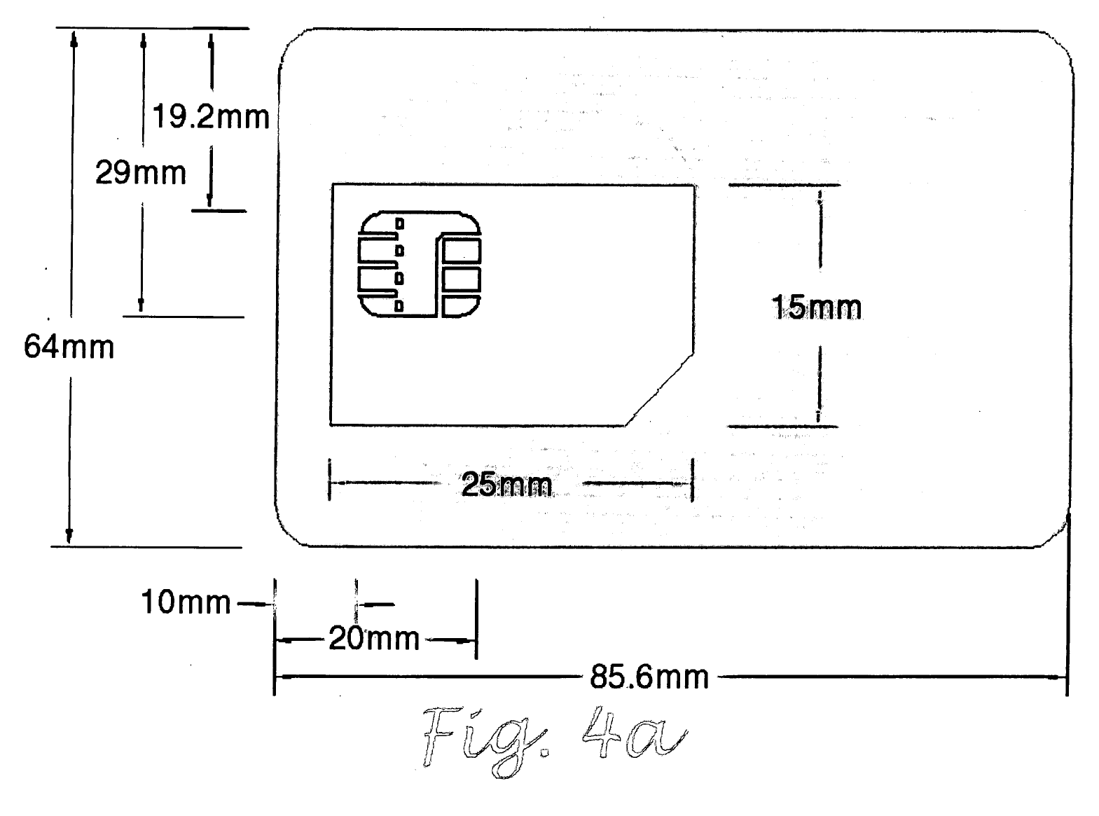

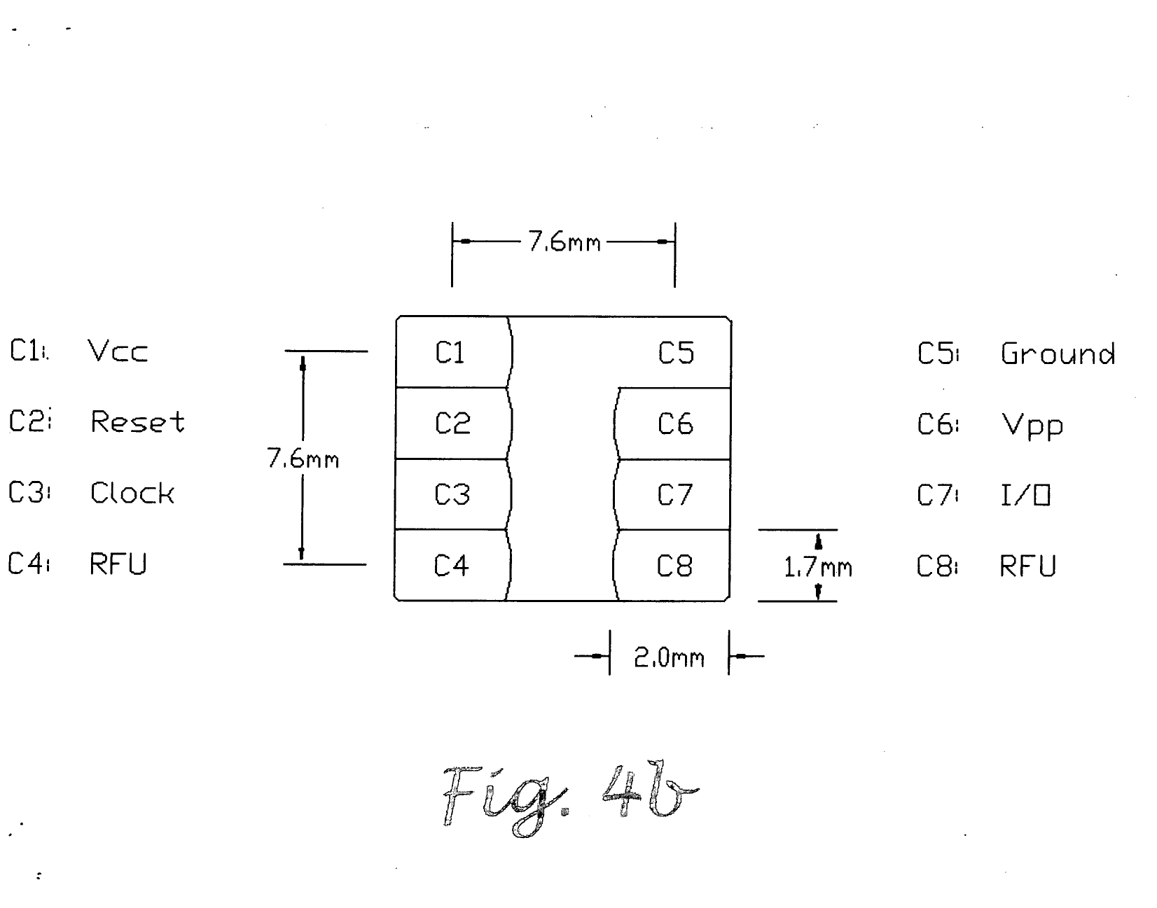

A Subscriber Identity Module (SIM) contains the following: (a) International Mobile Subscriber Identity (IMSI), where the first 5 numbers define your home system; (b) individual subscribers authentication key (Ki); (c) ciphering key generating algorithm (A8)—with Ki and RAND, it generates a 64 bit key (Kc); (d) authentication algorithm (A3)—with Ki and RAND, it generates a 32 bit signed response (SRED); (e) user PIN code (1 & 2); (f) PUK code (1 & 2), which is also referred to as the SPIN; (g) user phone book; (h) Stored SMS messages; and (i) preferred networks list. A typical SIM card is shown in FIG. 4a of the drawing. Additional detail of the electronic component of the SIM card 28 is shown in FIG. 4b. A complete description of the SIM/ME interface can be found in the following references, well known to those skilled in the art of mobile phone technology: ETSI Technical Specification GSM 11.11 (113 pages) and ETSI Technical Specification GSM 11.14 (54 pages).

The new system and methodology according to the present invention for using a SIM card centers around the usage of the user phone book (item “g” above) for storing system configuration settings. The traditional usage for the user phone book area of the SIM storage area is to utilize the storage area for a unique identifier and an associated phone number. An example of a typical set of stored phone book records is shown in Table 1:

TABLE 1

| Name Identifier Field | Phone Number Field |
|---|---|
| Elvis Presley | 210 555 1234 |
| The President | 121 555 3214 |
| CUSTOMER Service | *611 |

This methodology utilized the SIM storage to store settings that would normally have to hard coded into the Mobil device. To configure the device the user simply removes the SIM module from the Mobil device (after powering down) and inserts it into a compatible wireless phone device that has the ability to edit the stored entries. The user then uses the wireless phone to store settings (in the Phone Number field) identified by Keywords (in the Name Field) using the mobile devices Phone number entry function. Table 2 illustrates an example of using the phone number entry function of a SIM card to store a set of device configuration settings:

TABLE 2

| | Phone Number | |
|---|---|---|
| Name Identifier Field | Field | Typical Usage |
| Auto Answer | 1 | 0 = auto answer; 1 = User |
| | | intervention |
| Speaker Volume | 3 | Speaker level 0 to 10; |
| | | 10 = loudest |
| Button Delay | 2 | How long before button is |
| | | acknowledged |
| Emergency Button | Yes | Is the Emergency button |
| | | installed? |

As can be seen from the above table SIM phone book entries are used to store a whole range of settings without the need for separate memory devices. Once the user has entered/updated the settings on the SIM card utilizing the wireless phone, Phone book entry interface the user re-inserts the SIM back into the target Mobil device. After a power is re-applied the Mobil device the contents of the Phone book area of the SIM card are read and utilized to configure the Mobil devices operation accordingly. Any mistyped entries could, for example, be indicated at system startup by a simple light (LED) interface.

This system and methodology provides a way of storing configuration settings in a new unusual way without the need for expensive configuration interfaces. The use of a separate phone for programming (which could be the low cost phone that the carrier gives away with the service). Software could be written to allow the settings to be automatically generated to a default level if the SIM card is new and has no entries. Software could be also written to update the SIM records remotely (possibly through a web interface) of a fleet setting needed changing (e.g. Auto answer is now active). This method utilizes the same configuration device (SIM) that is used to configure the network settings for the Mobil device without the need for additional memory storage devices (flash drives, switches etc.) The SIM card could also be utilized to store non volatile information about the operation of the Mobil device such as number of calls made or length of time of a call.

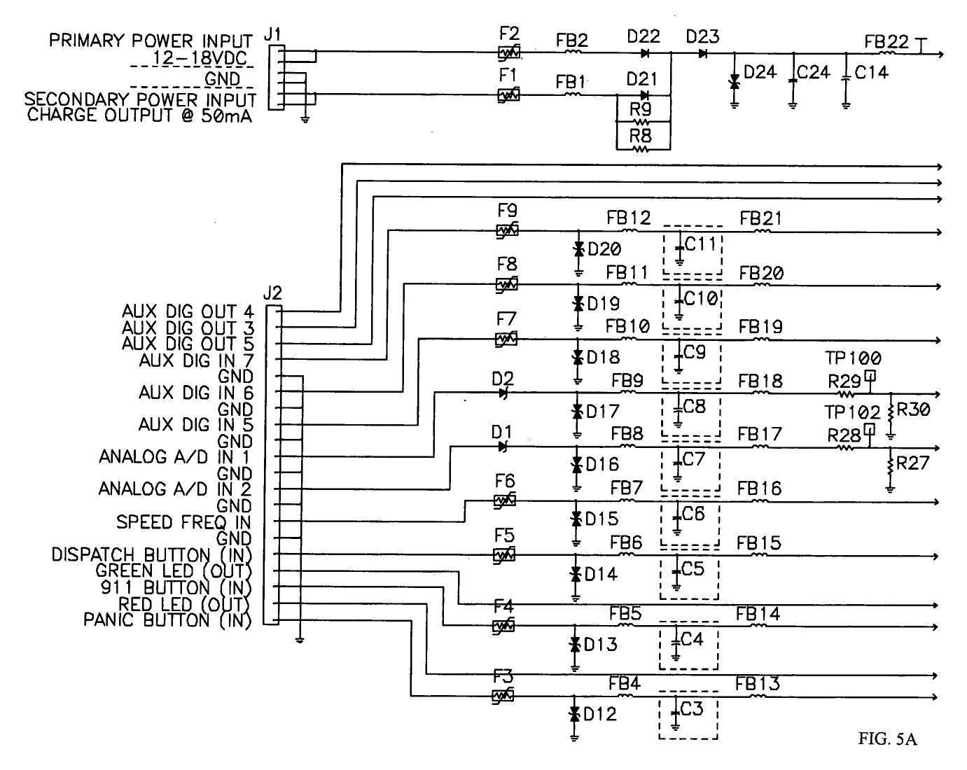

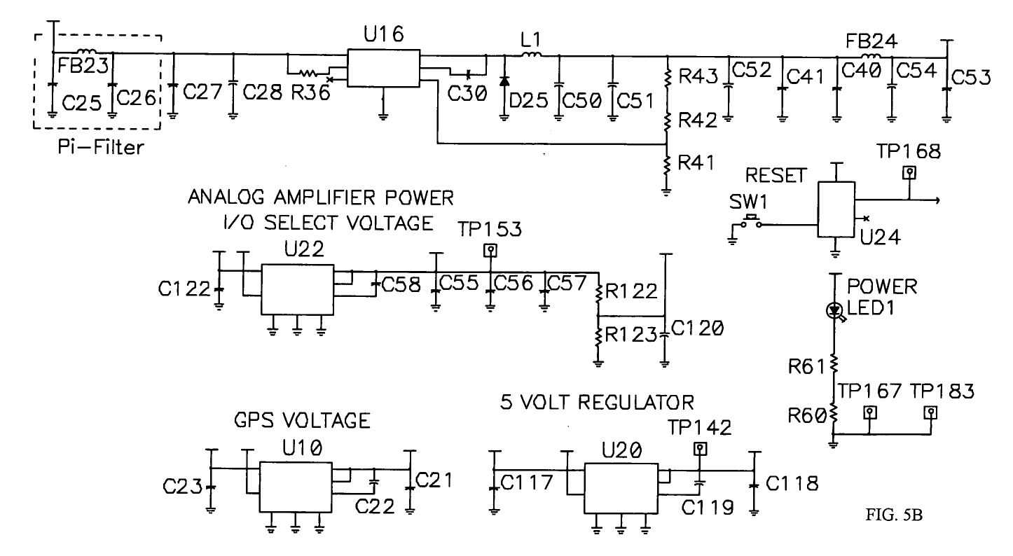

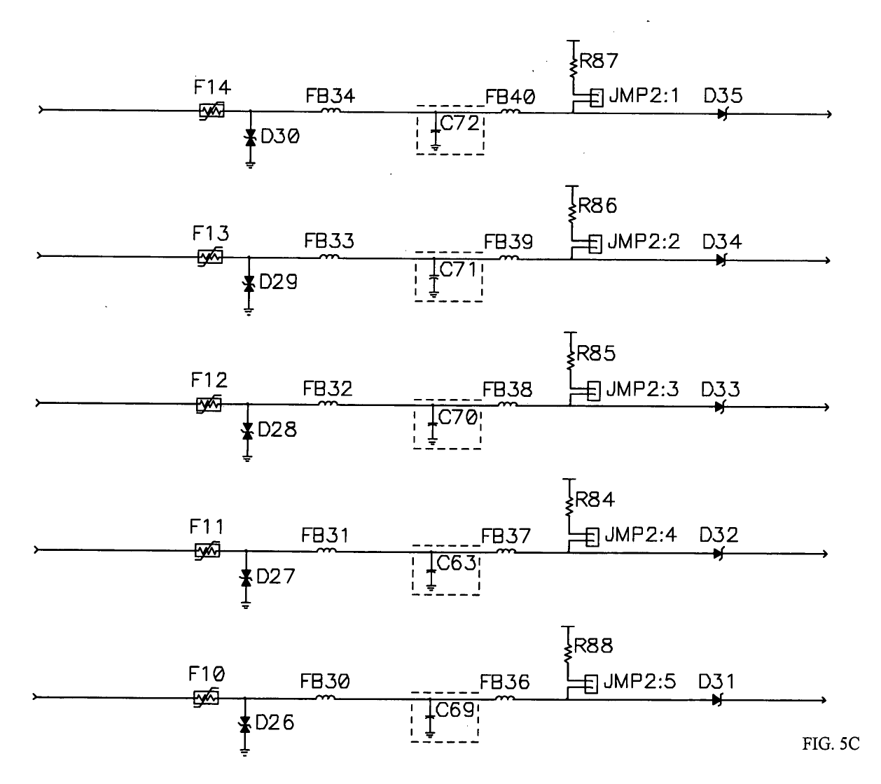

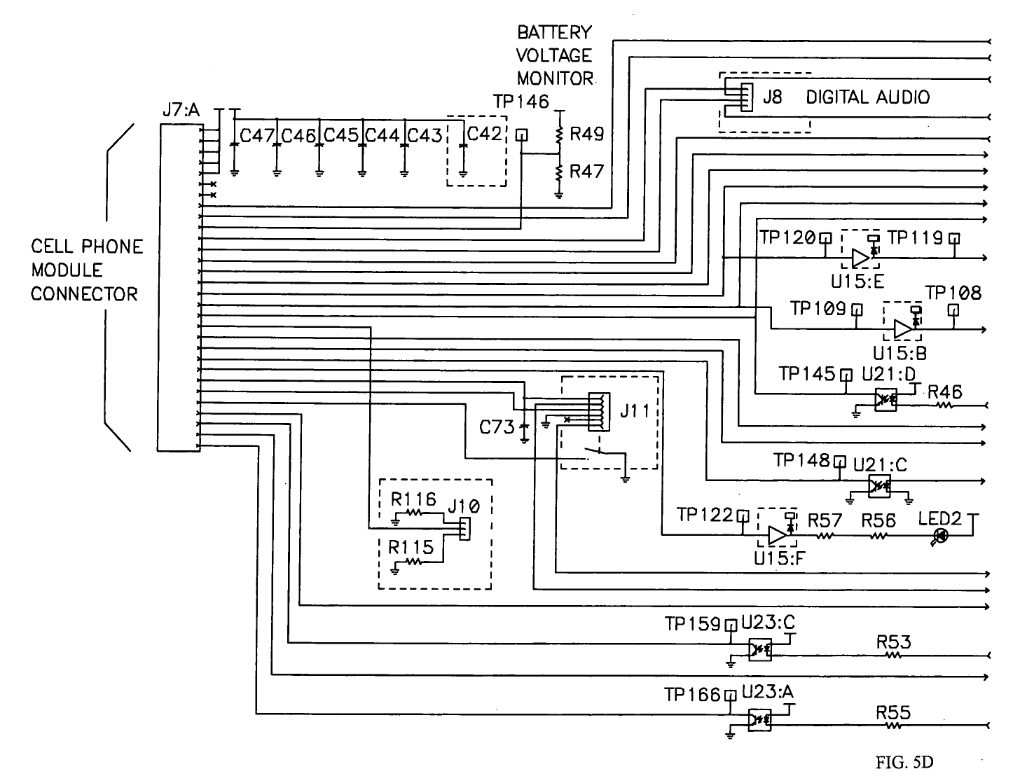

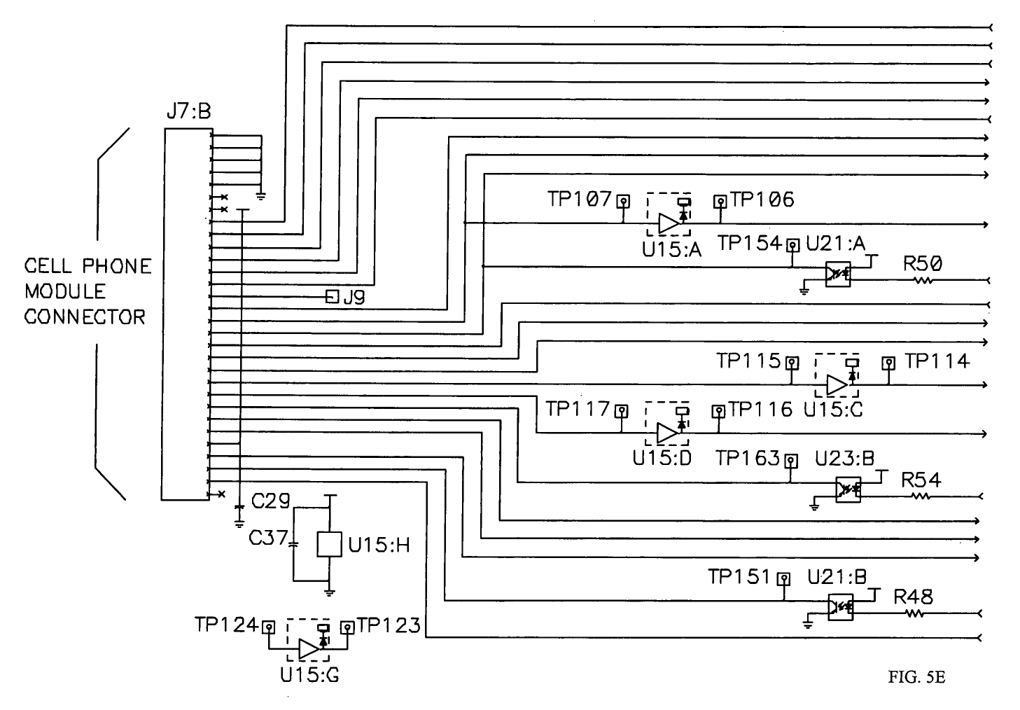

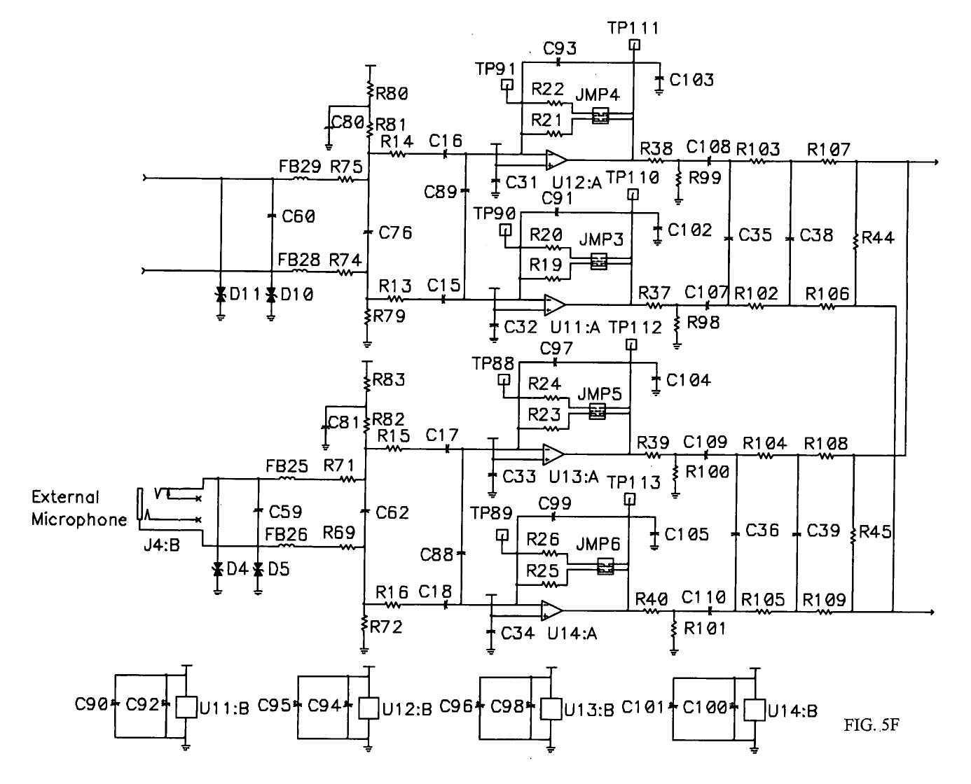

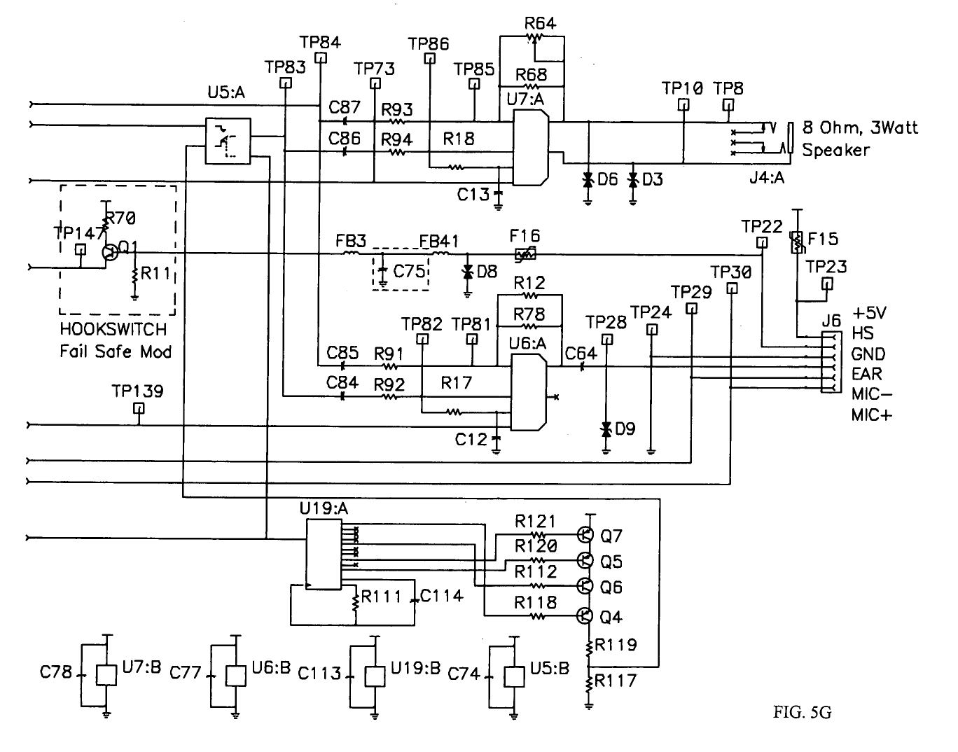

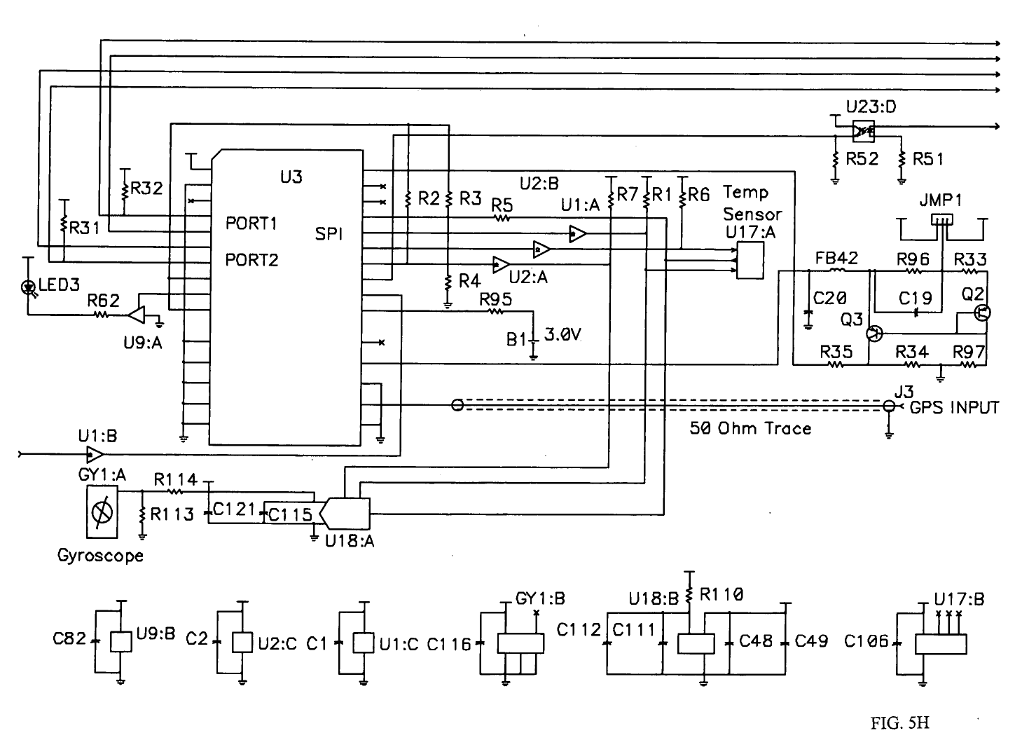

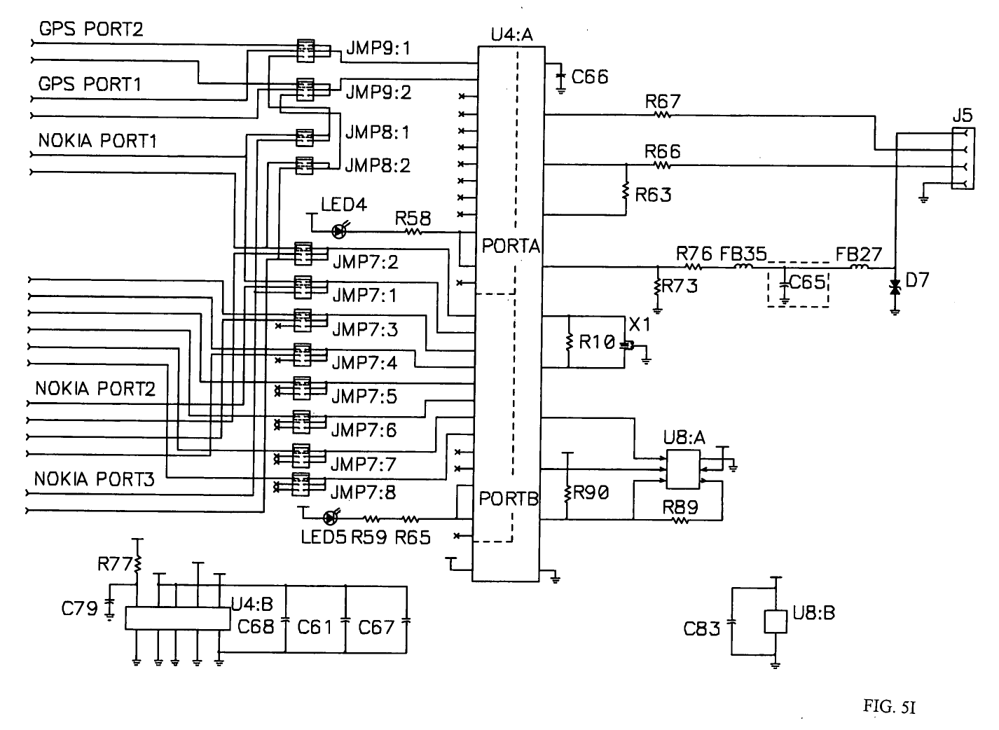

Although not believed to be necessary to the understanding of the invention, FIGS. 5a-5i of the drawing are a set of preliminary schematics of the electronics for one embodiment of a system according to the invention. FIG. 5a shows a schematic example for appropriate external input and output circuitry, which provides protection for input and outputs from over current, over voltage, and electrical noise suppression. FIG. 5b shows the power supplies & reset circuitry, which converts the incoming vehicle power (12 Volts DC nominal) to 3.8 volts, 3.3 volts, 3.0 volts and 5 volts. FIG. 5c shows additional input and output circuitry, which is an extension of FIG. 5a. FIG. 5d shows part of the NOKIA 12 Module Circuitry, which provides interfacing for the Nokia 12 Module odd numbered pins. FIG. 5e shows part of the NOKIA 12 Module Circuitry, which provides interfacing for the Nokia 12 Module even numbered pins. FIG. 5f shows the microphone audio amplifier circuitry, which provides dual microphone stimulation, protection, and amplification for the hands free and privacy microphones. FIG. 5g shows the handset earphone audio amplifier circuitry, which provides dual speaker dive, protection and amplification for the hand free and privacy speakers. FIG. 5h shows the GPS circuitry, which provides GPS circuitry to acquire vehicle position from GPS satellites and circuitry to acquire information from the gyroscope. FIG. 5i shows the USB circuitry, which provides Dual port USB circuitry to allow interfacing with any of the three Nokia UART Ports and any of the GPS UART Ports.

According to a further aspect of the invention, a method is provided for controlling the engine idle time of a vehicle. The method includes the steps of: operatively connecting at least one temperature sensor to measure the temperature of at least one part of the vehicle; operatively connecting the at least one temperature sensor to a computer; operatively connecting an engine start/stop controller to the engine of the vehicle; operatively connecting the engine start/stop controller to the computer; using the computer to start the engine when the at least one temperature sensor reports a temperature that is outside of a settable temperature range; and using the computer to stop the engine when the at least one temperature sensor reports a temperature that is within a settable temperature range.

The temperature sensor is preferably connected to measure a temperature parameter of the engine to reduce the need for engine cold starts, which are highly detrimental to the engine life. A temperature sensor can be connected to detect the temperature of the operator cabin, passenger cabin, or payload cabin, whereby the engine can run for the purposes of maintaining a desired temperature range in any one or more of such areas when the vehicle is not parked. This is useful, for example, when the operator of the vehicle is taking a rest or sleep inside the vehicle and desires to have the engine run an adequate amount of time to maintain a comfortable cabin temperature but does not want to personally monitor the idling of the engine to avoid the consumption of unnecessary fuel to maintain the desired cabin temperature.

The desired temperature ranges to be maintained can be set by the operator of the vehicle or can be predetermined and programmed into the computer. In addition, the minimum or maximum temperature limits may be programmed into the system within which the operator may set the temperature range for personal comfort, passenger comfort, or payload protection, as the case may be.

It is also to be understood, of course, that the computer can also be operatively connected to the vehicle to detect when the vehicle is parked (i.e., when the engine is not in gear) so that the engine of the vehicle is not shut down while being operated in traffic.

The invention is described with respect to presently preferred embodiments, but is not intended to be limited to the described embodiments. As will be readily apparent to those of ordinary skill in the art, numerous modifications and combinations of the various aspects of the invention and the various features of the preferred embodiment can be made without departing from the scope and spirit of the invention. The invention is to be defined by the appended claims.

It should also be understood, for example, that the function of a single structure or module described herein can sometimes be performed by more than one part, or the functions of two different structures or modules can be performed by a single or integrally formed part. Especially from manufacturing and cost perspectives, it is preferred to design the device to minimize the number of parts. These costs include not only the costs associated with making the parts, but also the costs of assembly. Preferably, the fewest possible number of parts and steps required to manufacture and assemble the apparatus, the better.

1. A system adapted to be operably connected to a vehicle for use in management of the vehicle, the system comprising:
a. a computer;
b. a wireless communication module operably connected to the computer;
c. an audio interface operably connected to the computer;
d. a GPS receiver module operably connected to the computer
e. at least one vehicle condition sensor operably connected to the computer;
f. a local control interface operably connected to the computer; and
g. an engine start/stop controller operably connected to the computer.

2. A system according to claim 1, further comprising: a subscriber identity module operably connected to the computer.

3. A system according to claim 2, further comprising: a gyroscope module operably connected to the GPS receiver module.

4. A system according to claim 1, further comprising: a gyroscope module operably connected to the GPS receiver module.

5. A system adapted to be operably connected to a vehicle for use in management of the vehicle, the system comprising:
a. a computer;
b. a wireless communication module operably connected to the computer;
c. an audio interface operably connected to the computer;
d. a GPS receiver module operably connected to the computer;
e. at least one vehicle condition sensor operably connected to the computer;
f. a local control interface operably connected to the computer; and
g. a subscriber identity module operably connected to the computer.

6. A system according to claim 5, further comprising: an engine start/stop controller operably connected to the computer.

7. A system according to claim 6, further comprising: a gyroscope module operably connected to the GPS receiver module.

8. A system according to claim 5, further comprising: a gyroscope module operably connected to the GPS received module.

9. A system adapted to be operably connected to a vehicle for use in management of the vehicle, the system comprising:
a. a computer;
b. a wireless communication module operably connected to the computer;
c. an audio interface operably connected to the computer;
d. a GPS receiver module operably connected to the computer;
e. at least one vehicle condition sensor operably connected to the computer;
f. a local control interface operably connected to the computer; and
g. a gyroscope device operably connected to the GPS receiver module.

10. A system according to claim 9, further comprising: an engine start/stop controller operably connected to the computer.

11. A system according to claim 10, further comprising: a subscriber identity module operably connected to the computer.

12. A system according to claim 9, further comprising: a subscriber identity module operably connected to the computer.

13-19. (canceled)
